(19) United States
(12) Patent Application Publication
(10) Pub. No.: US 2016/0127296 A1
(43) Pub. Date: May 5, 2016

(54) EMAIL SYSTEM AND METHOD FOR SENDING DESIGNATED CONTENTS OF EMAILS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: KUI-JUN WANG, Shenzhen (CN); CHIH-SAN CHIANG, New Taipei (TW)

(21) Appl. No.: 14/584,608

(22) Filed: Dec. 29, 2014

(30) Foreign Application Priority Data
Oct. 31, 2014 (CN) 201410608680.5

(51) Int. Cl. H04L 12/58

(52) U.S. Cl. CPC H04L 51/22

(57) ABSTRACT

A method for sending and receiving an email includes providing an email interface for an email sender to compose the email, inputting a number of recipients and an email message of the email to corresponding input fields of the email interface, setting a reading privilege for each recipient, sending the email to the number of recipients according to the reading privileges, and receiving the email sent from the email sender. The email received by each recipient only contains designated contents of the email according to the reading privilege set by the email sender.

### FIELD

The subject matter herein relates to a system and method for sending designated contents of an email to a plurality of recipients.

### BACKGROUND

Generally, when sending an email message to a plurality of recipients, all of the recipients receive the same email message.

### BRIEF DESCRIPTION OF THE DRAWINGS

Implementations of the present technology will now be described, by way of example only, with reference to the attached figures.

FIG. 1 is a diagrammatic view of an exemplary embodiment of a system for sending an email through an encryption system.

FIG. 2 is a block diagram of an exemplary embodiment of an electronic device including the encryption system.

FIG. 3 is a diagrammatic view of an exemplary embodiment of an email interface for composing the email.

FIG. 4 is a diagrammatic view of an exemplary embodiment of a settings interface.

FIG. 5 is a diagrammatic view of an exemplary embodiment of a previewing interface.

FIG. 6 is a flowchart of an exemplary method for sending an email to a plurality of recipients.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

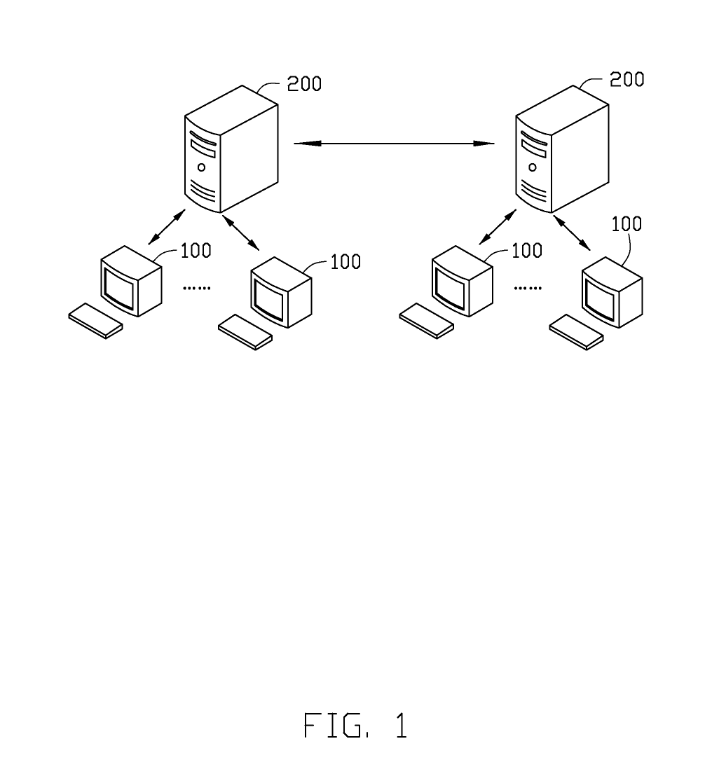

FIG. 1 illustrates an exemplary embodiment of an operating environment of a system for sending and receiving an email. The system can include a plurality of electronic devices 100 and at least one server 200. The email can be sent from an email sender to a plurality of recipients. The email can be sent and received by corresponding email servers, such as GMAIL®, YAHOO MAIL®, or the like. The email can be sent and received on different electronic devices 100, or on the same electronic device 100. The plurality of electronic devices 100 can be coupled to each other through the at least one server 200.

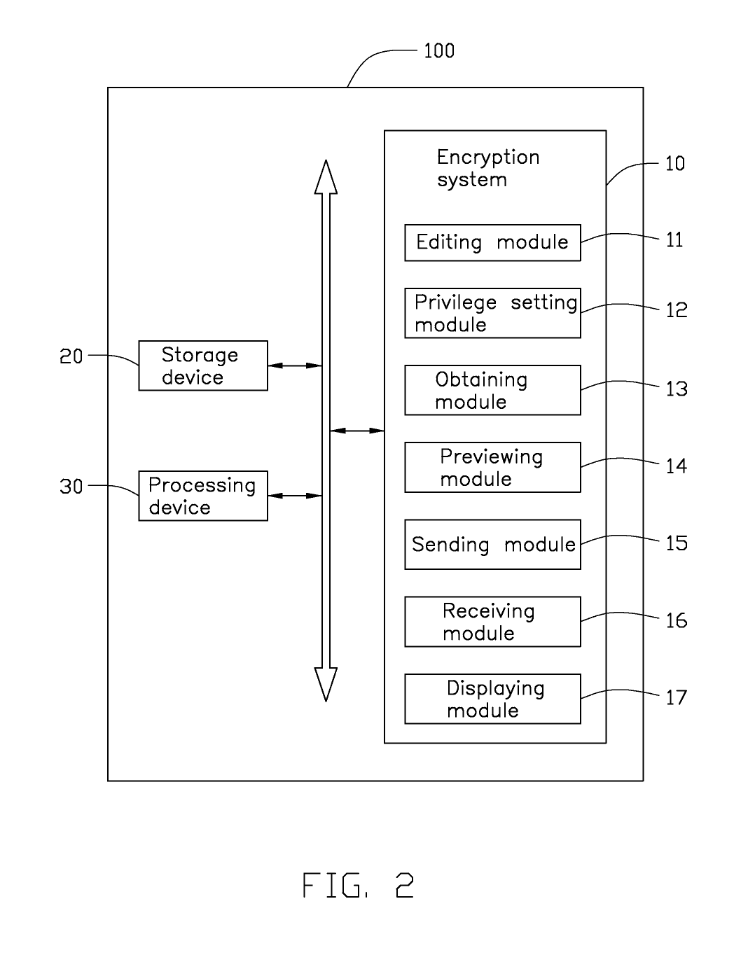

Referring to FIG. 2, each electronic device 100 can include an encryption system 10, a storage unit 20, and a processing unit 30. The email can be sent to the receiving user terminals through the server by using the encryption system 10. The encryption system 10 can include a plurality of modules, such as an editing module 11, a privilege setting module 12, an obtaining module 13, a previewing module 14, a sending module 15, a receiving module 16, and a displaying module 17. The modules 11-17 can comprise one or more software programs in the form of computerized codes stored in the storage unit 20. The computerized codes can include instructions executed by the processing device 30 to provide functions for the modules 11-17.

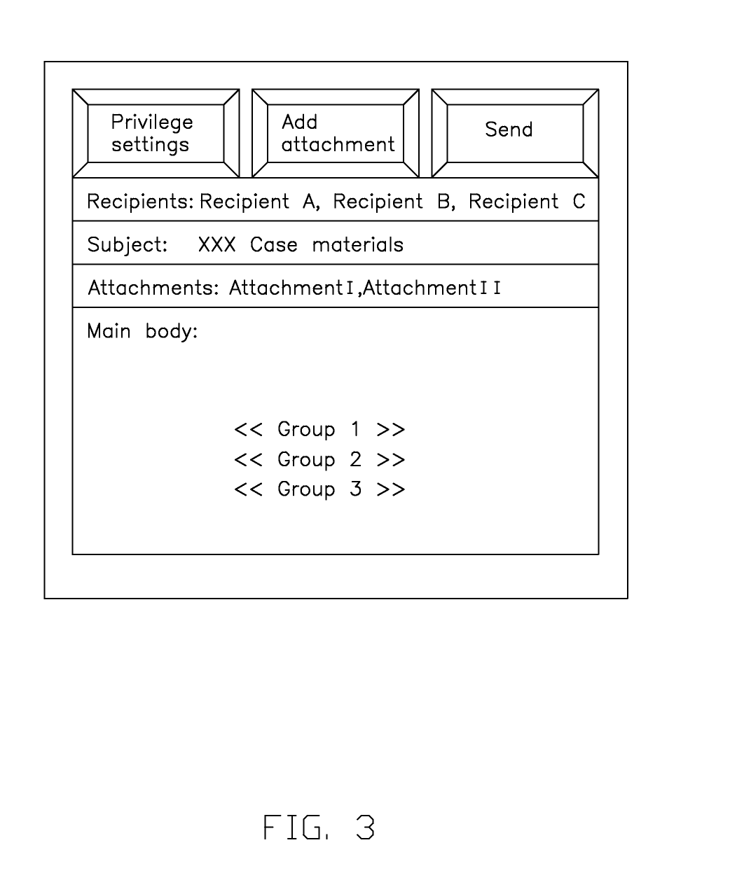

Referring to FIG. 3, the editing module can provide an email interface for the email sender to compose the email. The email interface can include a plurality of input fields, such as a recipient input field, an attachment field, and a main body field. The plurality of recipients can be input to the recipient field. Each recipient can correspond to an email address. The attachment field and the main body field can be the input fields of an email message of the email. The attachment field can be used for attaching a plurality of attachments to the email message. The main body field can be used for inputting groups of text of the email message. For clarity of illustration, the plurality of recipients include a recipient A, a recipient B, and a recipient C, the attachments include an attachment I and an attachment II, and the groups of text include a group 1, a group 2, and a group 3.

In at least one embodiment, the storage device can store a plurality of relationships set by the editing module. Each relationship can include the email address and a plurality of keywords of each recipient. For example, the plurality of keywords can include a name of the recipient and a work code of the recipient. The recipients can be input to the recipient field of the email interface by inputting one of the keywords of the recipient. When there is no relationship of the recipient stored in the storage device, the email address of the recipient can be input directly.

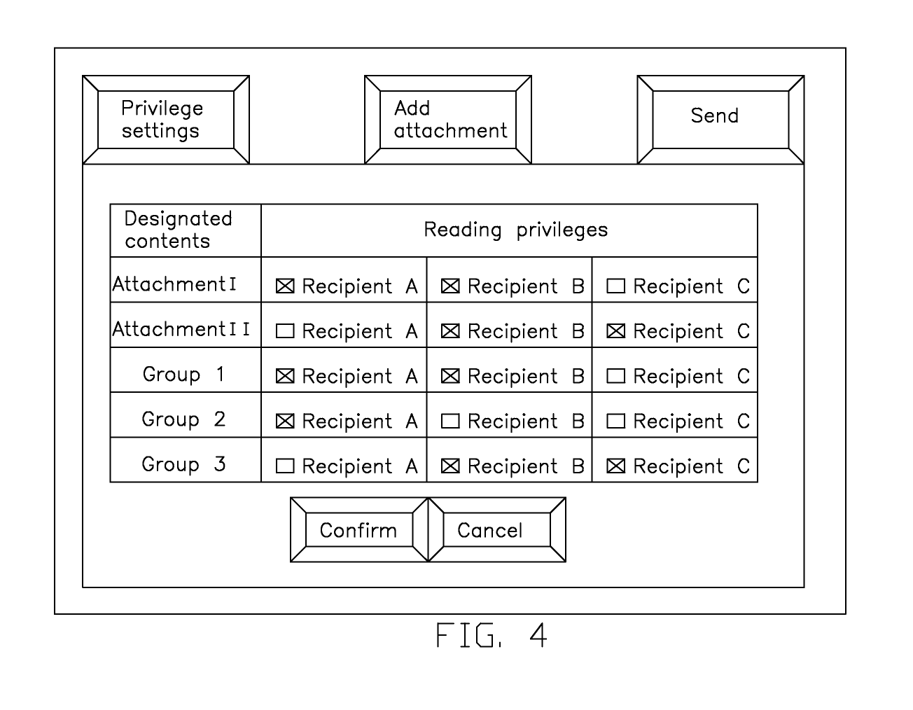

Referring to FIG. 4, the privilege setting module can provide a settings interface for setting a reading privilege for each of the recipients. The reading privilege sets designated contents of the email message to be seen by each of the recipients. Thus, each of the recipients can only receive the designated contents of the email message set by the privilege setting module. The designated contents can include the attachments attached to the attachment field, and the groups of text of the main body field. In at least one embodiment, the designated contents to be sent to each recipient are set by selecting a checkbox of the recipients for each of the designated contents. As illustrated, the attachment I can be seen by the recipients A and B, and the group 3 can be seen by the recipients B and C.

The obtaining module can obtain the email address of the recipients corresponding to the keywords input to the recipient field according to the relationships stored in the storage device, and also obtain the reading privileges set by the privilege setting module.

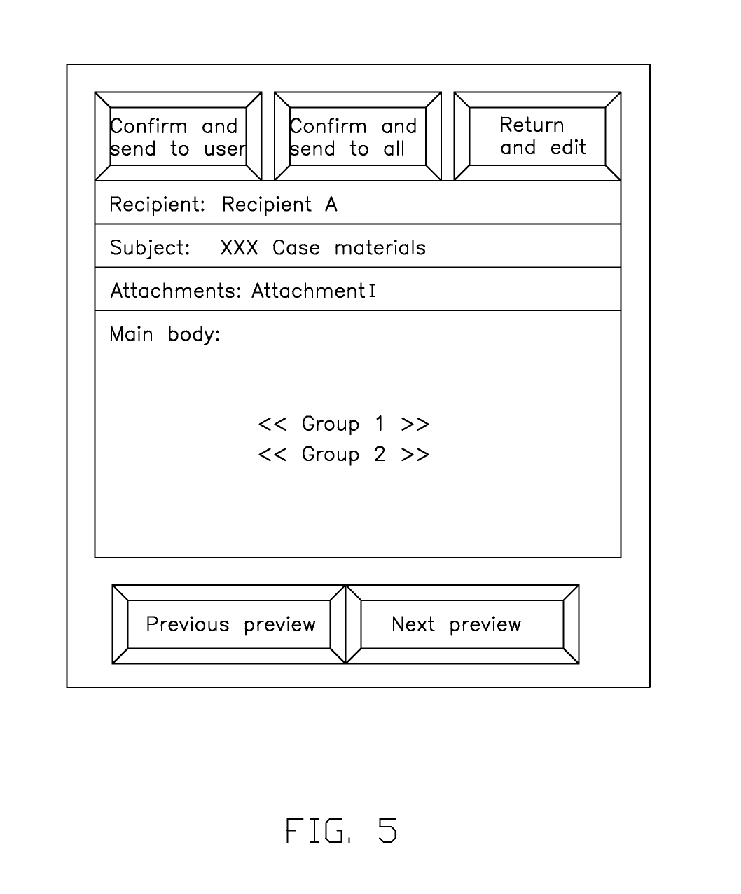

Referring to FIG. 5, the previewing module can provide a previewing interface for previewing the designated contents to be sent to each recipient. As illustrated, the recipient A can only see the attachment I and the groups 1 and 2.

The sending module can send the email from the email sender to the plurality of recipients. The sending module sends the email with the corresponding designated contents to each recipient according to the reading privileges obtained by the obtaining module.

The receiving module can receive the email from the sending module.

The displaying module can display the designated contents of the email.

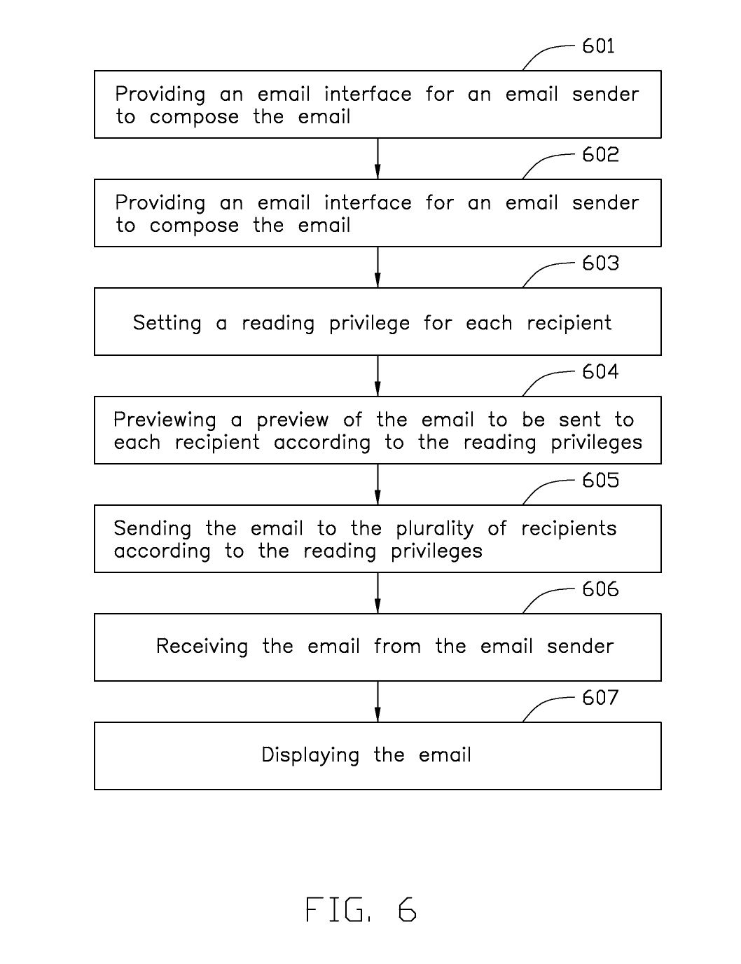

FIG. 6 illustrates a flowchart of an exemplary method for sending and receiving an email. The example method is provided by way of example, as there are a variety of ways to carry out the method. The method described below can be carried out using the configurations illustrated in FIGS. 1-5, for example, and various elements of these figures are referenced in explaining the example method. Each block shown in FIG. 6 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 601.

At block 601, an email interface can be provided for an email sender to compose the email. The email interface can include a recipient field for inputting a plurality of recipients to receive the email, and corresponding input fields for inputting an email message.

At block 602, the plurality of recipients and the email message can be input to the email interface. Each recipient corresponds to one email address. The email message can include a plurality of attachments input to an attachment field, and groups of text input to a main body field.

At block 603, a reading privilege can be set for each recipient. The reading privilege sets designated contents of the email message to be sent to the recipients. The designated contents include the attachments and the groups of text.

At block 604, a preview of the email to be sent to each recipient can be previewed. The email to be sent to each recipient only contains the designated contents set by the reading privileges.

At block 605, the email can be sent to the plurality of recipients according to the reading privileges.

At block 606, the email can be received by the recipients.

At block 607, the email can be displayed.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for sending and receiving an email, the method comprising:
providing an email interface for an email sender to compose the email;
inputting a plurality of recipients and an email message of the email to corresponding input fields of the email interface, each recipient from the plurality of recipients corresponding to one email address;
setting a reading privilege for each recipient from the plurality of recipients; and
sending the email to the plurality of recipients according to the reading privileges; wherein:
the email received by each recipient only contains designated contents of the email according to the reading privilege.

2. The method as in claim 1 further comprising:
displaying a preview of the designated contents to be sent to each recipient in a previewing interface before sending the email to the plurality of recipients.

3. The method as in claim 1, wherein the recipients are input to a recipient field of the email interface; and methods of inputting the recipients comprise inputting email addresses of the recipients, and inputting related keywords of the recipients.

4. The method as in claim 1, wherein:
input fields of the email message comprise an attachment field and a main body field;
the designated contents of the attachment field comprise attachments attached thereto; and
the designated contents of the main body field comprise groups of text input to the main body field.

5. The method as in claim 4, wherein each group of text of the main body field is designated by a predefined symbol.

6. The method as in claim 5, wherein the predefined symbol for designating each group of text of the main body field is a pair of predefined brackets surrounding the group of text.

7. The method as in claim 4, wherein the reading privileges are set by selecting the recipients to receive the designated contents.

8. The method as in claim 7, wherein the recipients are selected by checking a selection box of the recipients in a corresponding settings interface.

9. A system for sending and receiving an email, the system comprising:
at least one electronic device running an encryption system, the at least one electronic device used by an email sender and a plurality of recipients; and
at least one server coupled to the at least one electronic device to allow the email sender to send the email to the plurality of recipients through the encryption system, the at least one electronic device comprising:
a storage unit configured to store a plurality of instructions of a plurality of modules of the encryption system; and
a processing unit configured to execute the plurality of instructions of the plurality of modules of the encryption system, the plurality of modules comprising:
an interface generating module configured to display an email interface for the email sender to compose the email;
a privilege setting module configured to set a reading privilege of the plurality of recipients;
an obtaining module configured to obtain the plurality of recipients and the reading privileges;
a sending module configured to send the email to the plurality of recipients according to the reading privileges;
a receiving module configured to receive the email sent by the email sender; and
a displaying module configured to display the email for the plurality of recipients; wherein:
the email comprises the plurality of recipients and an email message;
the plurality of recipients is input to a recipient field of the email interface, and the email message is input to corresponding input fields of the email interface;
the reading privilege sets designated contents of the email message to be sent to each recipient; and
the email is sent by an email server of the email sender, and received by corresponding email servers of the recipients.

10. The system as in claim 9, wherein the plurality of modules further comprises a previewing module configured to display a preview of the designated contents of the email to be sent to each recipient, and the previews are displayed in a previewing interface generated by the previewing module.

11. The system as in claim 9, wherein each recipient corresponds to an email address of the corresponding email server.

12. The system as in claim 9, wherein the email message comprises attachments attached to an attachment field of the email interface, and designated groups of text input to a main body field of the email interface.

13. The system as in claim 12, wherein the groups of text are designated by a predefined symbol.

14. The system as in claim 13, wherein the predefined symbol is a pair of predefined brackets surrounding the group of text to be designated.

15. The system as in claim 12, wherein:
the storage unit stores a plurality of relationships set by the editing module;
each relationship comprises an email address and a plurality of keywords of each recipient; and
the plurality of keywords comprises a name of the recipient and a work code of the recipient.

16. The system as in claim 15, wherein methods for inputting the recipients to the recipient field comprise entering keywords of the recipients, and entering the email address when the keywords are not stored in the storage unit.

17. The system as in claim 12, wherein the privilege setting module provides a settings interface for selecting the recipients to view the designated contents.

18. The system as in claim 17, wherein the recipients are selected by selecting a check box of the recipients for each of the designated contents.

19. The system as in claim 18, wherein each of the recipients only receives the corresponding designated contents according to the reading privilege set by the privilege setting module.
